(19) United States
(12) Patent Application Publication
(10) Pub. No.: US 2009/0047643 A1
(43) Pub. Date: Feb. 19, 2009

(54) Method and Apparatus for Improving the Effectiveness and Efficiency of a Group

(75) Inventors: Max Isaac, Toronto (CA); Kevin Carson, Marysville, OH (US)

Correspondence Address: CHALKER FLORES, LLP, 2711 LBJ FRWY, Suite 1036, DALLAS, TX, 75234, US

(73) Assignee: 3CIRCLE PARTNERS, LLP, Atlanta, GA (US)

(21) Appl. No.: 12/101,133

(22) Filed: Apr. 10, 2008

Related U.S. Application Data
(60) Provisional application No. 60/910,826, filed on Apr. 10, 2007.

(51) Int. Cl. G09B 19/00

(52) U.S. Cl. 434/237

(57) ABSTRACT

The present invention provides a method and system for improving an effectiveness and efficiency of a group having two or more individuals by (a) receiving data for each individual in the group relating to the effectiveness and efficiency of the group, (b) analyzing the received data, (c) providing an assessment of each individual and the group based on the analyzed data, and (d) repeating steps (a), (b) and (c) after a specified time period. The assessment includes three or more assessment outputs selected from a group comprising a FEMA overview, a Belbin team map, a learning cycle scorecard, a participation timeline, an equality index, a power gap and a decision stream analysis. The method can be implemented using a computer readable medium encoded with a computer program wherein the steps are performed by one or more code segments.

### PRIORITY CLAIM TO RELATED APPLICATIONS

This patent application is a non-provisional application of U.S. provisional patent application 60/910,826 filed on Apr. 10, 2007 and entitled “Method and Apparatus for Improving the Effectiveness and Efficiency of a Group” which is hereby incorporated by reference in its entirety.

### FIELD OF THE INVENTION

The present invention relates generally to the field of organizational management and efficiency and, more particularly, to a method and apparatus for improving the effectiveness and efficiency of a group.

### BACKGROUND OF THE INVENTION

The results of an organization are a direct consequence of the performance of its teams (operational or leadership groups). Yet a typical team uses barely one third of its people resources and capabilities. In fact, experienced senior teams may operate at only a fraction of the effectiveness and efficiency of that of high performance teams. The leaders of an organization genuinely want, and strive for great team performance, but they do not know how to go about actually making it happen. The consequences of both good and bad interaction in the top team are subject to a powerful magnifying effect as they are transmitted throughout the organization. Demonstrating tangible improvements in the top team performance sets the tone for every other team in the company.

A top team usually needs to interact in several distinctive ways, often in parallel: (1) one on one; (2) one on some; and (3) one on all. The common elements required for rapid quality decisions are the right balance of people, an effective process, the appropriate interaction from the people involved, and the necessary experience and data. But there is typically a significant gap between perception and reality on the role, structure and functioning of a top team. As a result, an appropriate framework and methodology to systematically improve team performance is lacking.

Accordingly there is a need for a method and apparatus for improving the effectiveness and efficiency of a group that provides measurable results.

### SUMMARY OF THE INVENTION

The present invention provides a method and apparatus for improving the effectiveness and efficiency of a group that provides measurable results. The present invention provides a process that enables the discovery of barriers to learning and facilitates the creation and production of solutions that lead to high performance teamwork (better results, faster). The assessment process provides various qualitative and quantitative outputs that measure the effectiveness and efficiency of the group. The assessment outputs can be used by individual interviews to better understand the major issues facing the team and direct observation of team interactions, both at the top team level and lower layers.

One embodiment of the present invention provides a method for improving an effectiveness and efficiency of a group having two or more individuals by (a) receiving data for each individual in the group relating to the effectiveness and efficiency of the group, (b) analyzing the received data, (c) providing an assessment of each individual and the group based on the analyzed data, and (d) repeating steps (a), (b) and (c) after a specified time period. The assessment includes three or more assessment outputs selected from a group comprising a FEMA overview, a Belbin team map, a learning cycle scorecard, a participation timeline, an equality index, a power gap and a decision stream analysis. The method can be implemented using computer readable medium encoded with a computer program wherein the steps are performed by one or more code segments.

Another embodiment of the present invention provides an apparatus for improving an effectiveness and efficiency of a group having two or more individuals. The apparatus includes a memory, one or more input/output devices and a processor communicably coupled to the memory and the input/output device(s). The processor is configured to (a) receive data for each individual in the group relating to the effectiveness and efficiency of the group via the input/output device(s), (b) analyze the received data, (c) provide an assessment via the input/output device(s) of each individual and the group based on the analyzed data wherein the assessment comprises three or more assessment outputs selected from a group comprising a FEMA overview, a Belbin team map, a learning cycle scorecard, a participation timeline, an equality index, a power gap and a decision stream analysis, and repeat (a), (b) and (c) after a specified time period.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a flow chart of a method for improving the effectiveness and efficiency of a group in accordance with one embodiment of the present invention;

FIG. 2 is a block diagram of an apparatus in accordance with another embodiment of the present invention;

FIG. 3 is a time line illustrating three phases of the present invention;

FIG. 4 is a time line illustrating an example of the three phases of the present invention;

FIGS. 5A-5B are flow charts of a method for improving the effectiveness and efficiency of a group in accordance with another embodiment of the present invention;

FIG. 6 is a block diagram of an example of topics used in a workshop in accordance with the present invention;

FIG. 7 is an example of a FEMA overview for one issue for an individual in accordance with the present invention;

FIG. 8 is an example of a learning cycle scorecard for an individual in accordance with the present invention;

FIG. 9 is an example of a Belbin team map for a group in accordance with the present invention;

FIG. 10 is an example of a participation rate graph for a group in accordance with the present invention;

FIG. 11 is an example of a participation timeline for a group in accordance with the present invention;

FIG. 12 is an example of definitions for a decision stream analysis in accordance with the present invention;

FIG. 13 is an example of a summary for a decision stream analysis in accordance with the present invention;

FIGS. 14 and 15 are examples of graphs of raw data for a decision stream analysis in accordance with the present invention; and

FIG. 16 is a graph of an example of decision styles in accordance with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to team assessment within an organization, but it will be understood that the concepts of the present invention are applicable to any group of individuals whether in an organization or not.

Organizations of any size that understand the importance of collective performance that leverages off diverse talents for corporate success. Successful organizations need strong, coordinated corporate performance. The common elements required for rapid quality decisions are the right balance of people, an effective process, the appropriate interaction from the people involved and the necessary experience and data. The present invention implements a development plan for the group or leadership team that builds on previous development activities and facilitates the growth of the team to its full potential. The design principles are: (1) data driven and results focused (assesses the current state, establishes measures of team performance and re-assesses future performance); and (2) builds on the existing commitment to continuous improvement and takes into account team development activities in the past. A team map is used to measure the right balance of people and the effectiveness of the process. A team management system is used to measure the appropriate interaction from the people involved. Interaction metrics are used to measure the necessary experience and data.

The present invention provides a method and apparatus for improving the effectiveness and efficiency of a group that provides measurable results. The present invention provides a process that enables the discovery of barriers to learning and facilitates the creation and production of solutions that lead to high performance teamwork (better results, faster). The assessment process provides various qualitative and quantitative outputs that measure the effectiveness and efficiency of the group. The assessment outputs can be used by individual interviews to better understand the major issues facing the team and direct observation of team interactions, both at the top team level and lower layers.

The present invention uses a FACT-based approach (Forensics, Awareness, and Creating Transformation) to rapidly improve team performance and enable the acceleration of sustainable results. Forensics involves the use of hard data and metrics to analyze team performance in a tangible way. Acceleration provides “learning by doing” training that enables teams to experience real acceleration in their results. Change ensures continued performance through ongoing measurement and further training if and as necessary. The measurement of these follow-on activities allow for the prioritization of issues, development of remedial actions, prediction of new severity, occurrence, detection and risk priority number, and implementation and monitoring of steps to correct deficiencies. Tactics enable the integration and transfer of learning thoughout the organization, creating alignment and commitment rather than frustration and compliance.

This FACT-based approach provided the foundation for better and faster decisions, more ownership of decisions, improved interaction and communication, improved meeting effectiveness (more achieved in less time), using conflict as a positive instead of a negative force, optimized utilization of team member resources, and a common language with which to discuss previously “undiscussible” issues. Effective top team interaction, which requires commitment, quality of thinking and focus, is a vital prerequisite for sound strategy development and high quality execution.

Awareness encompasses accelerating results and alignment, beginning at the individual and team level where improvement is mutually reinforcing. The process is then duplicated through the teams of the organization. The individual needs to be self-aware and aware of others, which leads to self-management, which in turn leads to self-mastery. Similarly, the top team needs to be aligned and effective, which leads to multiple aligned and effective teams, which in turn leads to organization alignment and engagement.

Rather than trying to impose a “super-team” model, the FACT-based approach recognizes the realities of top group dynamics and provides the framework, awareness and tools to capitalize and improve on current performance:
FORENSICS provides a data-driven analytical framework for measuring, diagnosing and monitoring interaction and performance within the top team;
AWARENESS workshops facilitate an experiential training which illustrates the tools, techniques and methodology required for faster and better decision-making;
CREATING TRANSFORMATION monitors the improvement in team performance at measured intervals and can include further training, workshops or coaching as necessary for the team as they apply the team accelerator tools and methodology and can also include individualized executive coaching, both to further team development and best optimize executive effectiveness outside of team-based interactions; tactical actions are prepared in conjunction with the top team that will enable the acceleration of results of the other teams throughout the organization.

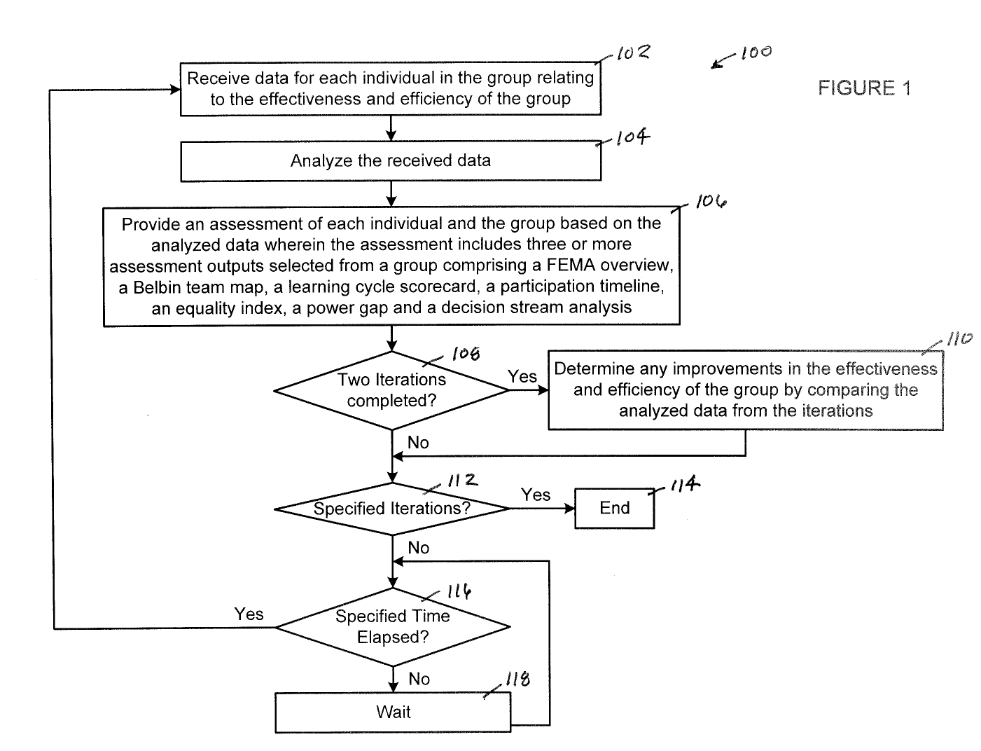

Now referring to FIG. 1, a flow chart of a method 100 for improving an effectiveness and efficiency of a group having two or more individuals in accordance with one embodiment of the present invention is shown. The group can be a management team, a production team, a project team, an assembly team, a division of an organization, a sector of the organization or the organization as a whole. Data is received for each individual in the group relating to the effectiveness and efficiency of the group in block 102 and the received data is analyzed in block 104. The data may include interview data, meeting observation data, video data or a combination thereof. Moreover, the data may fit within a data-driven analytical framework to measure, diagnose and monitor interaction and performance within the group. An assessment of each individual and the group based on the analyzed data is provided in block 106. The assessment includes three or more assessment outputs selected from a group comprising a FEMA overview, a Belbin team map, a learning cycle scorecard, a participation timeline, an equality index, a power gap and a decision stream analysis. If two or more iterations have been completed, as determined in decision block 108, any improvements in the effectiveness and efficiency of the group are determined and monitored by comparing the analyzed data from the iterations in block 110. If two or more iterations have not been completed, as determined in decision block 108, or the improvements have been determined in block 110, and a specified number of iterations have been performed, as determined in decision block 112, the process ends in block 114. If, however, the specified number of iterations has not been performed, as determined in decision block 112, and a specified time period has not elapsed, as determined in decision block 116, the process waits in block 118 until the specified time period has elapsed. The specified time period can be any time period, but is typically between one and six months. If, however, the specified time period has elapsed, as determined in decision block 116, the process loops back to block 1002 where additional data is received and the process repeats as previously described. The method can be implemented using a computer readable medium encoded with a computer program wherein the steps are performed by one or more code segments.

The analyzed data, assessments, improvements and training can be provided to the group in one or more workshops. The workshop may include three or more topics selected from a group comprising understanding leadership models, Belbin team roles and team map exercise, learning how to learn, personal feedback, recognizing leadership styles, double loop learning and team action planning. Furthermore, the workshop may facilitate an experiential training which illustrates a set of tools, techniques and methodology required for faster and better decision-making. Other steps may include: (1) providing additional training, workshops or coaching as necessary for the group to further team development and best optimize executive effectiveness outside of team-based interactions; (2) creating an action plan based on the assessment; or (3) providing additional training to one or more of the individuals or the group as a whole. The action plan may be prepared in conjunction with the group to enable an acceleration of results of other teams throughout an organization.

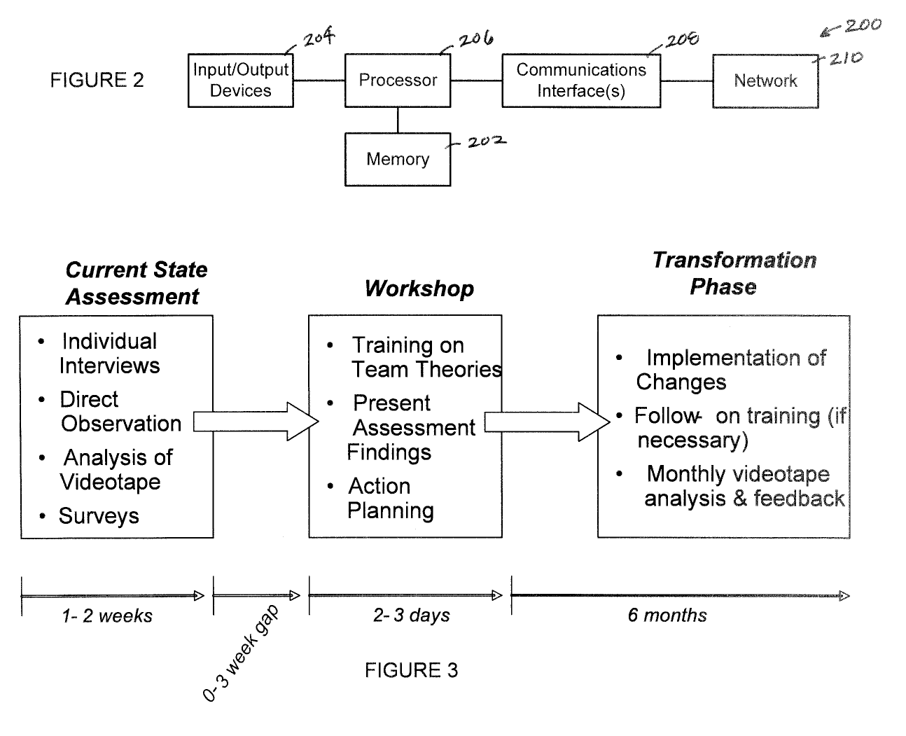

Referring now to FIG. 2, a block diagram of an apparatus 200 for improving an effectiveness and efficiency of a group having two or more individuals in accordance with another embodiment of the present invention is shown. The apparatus 200 includes a memory 202, one or more input/output device(s) 204 and a processor 206 communicably coupled to the memory 202 and the input/output device(s) 204. The apparatus 200 may also include one or more communications interface(s) 208 to communicably couple the processor 206 to a network 210 or other devices. The processor is configured to (a) receive data for each individual in the group relating to the effectiveness and efficiency of the group via the input/output device(s), (b) analyze the received data, (c) provide an assessment via the input/output device(s) of each individual and the group based on the analyzed data wherein the assessment comprises three or more assessment outputs selected from a group comprising a FEMA overview, a Belbin team map, a learning cycle scorecard, a participation timeline, an equality index, a power gap and a decision stream analysis, and repeat (a), (b) and (c) after a specified time period. The processor can also be configured to monitor any improvement in the effectiveness and efficiency of the group or create an action plan based on the assessment.

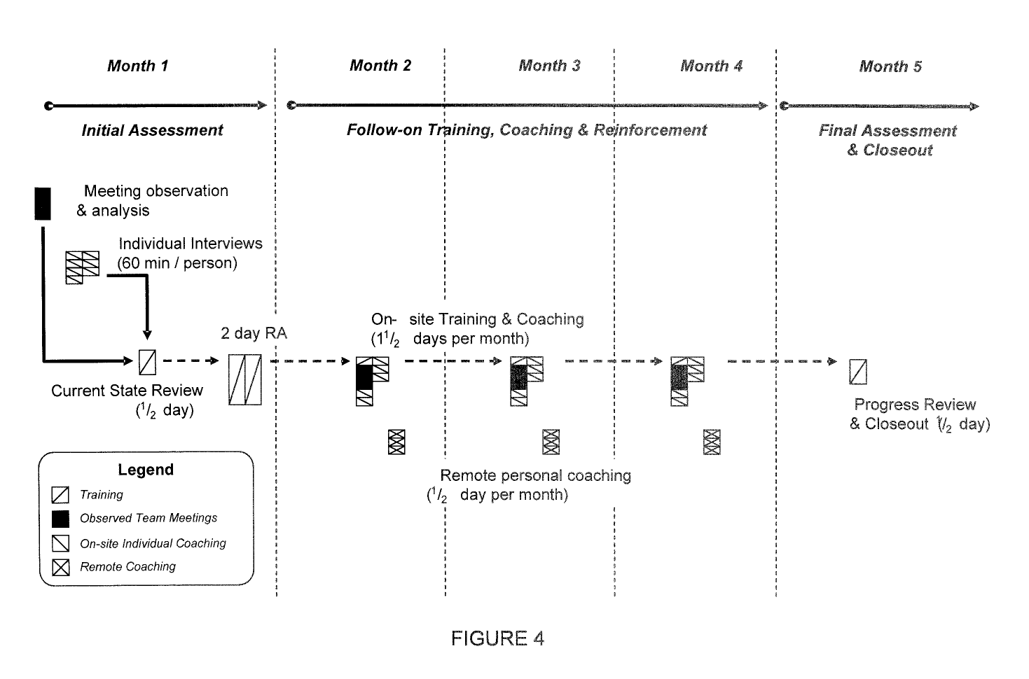

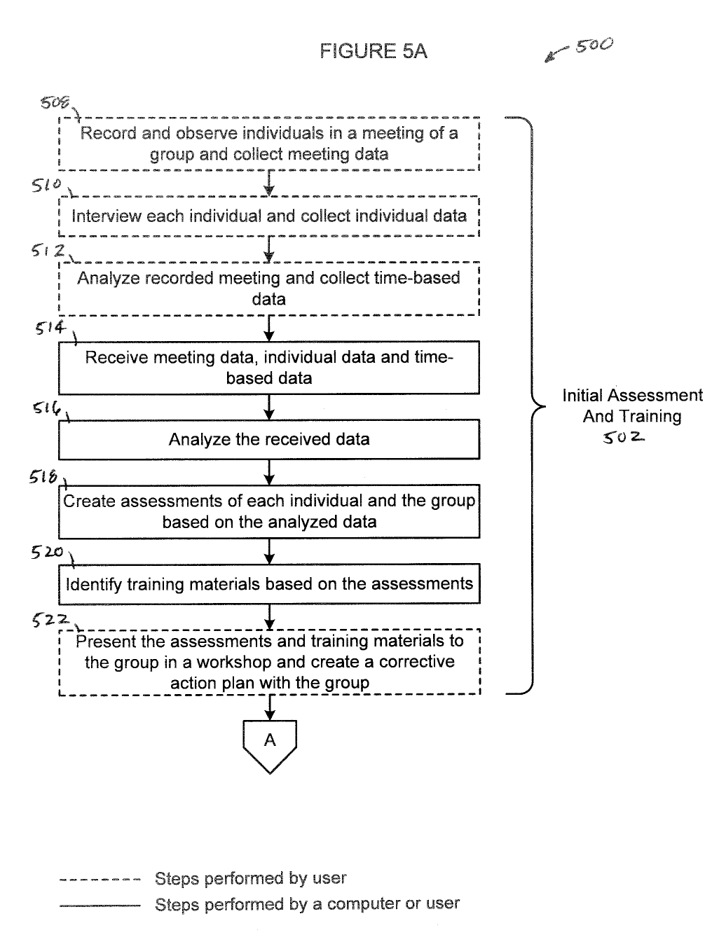

As shown in FIGS. 3 and 4, the FACT process has three phases: (1) Assessment and Baseline; (2) Interventions and Learning; and (3) Milestones Review. Phase One activities includes, member interviews, meeting observation and analysis, and presentation of findings and corrective action planning. Phase One outcomes include team effectiveness and efficiency baseline, team assessment of roles (Belbin), and a detailed learning plan. Phase Two activities include a two to three day results acceleration workshop and individual coaching as required. Phase Two outcomes include customized and applied learning, individual effectiveness (coaching), and team effectiveness and efficiency. Phase Three activities include second meeting observation, presentation of findings and further corrective action planning. Phase Three outcomes include team scorecard, formal feedback and continuous improvement capability.

Multiple assessment inputs are used to ensure consistency of findings: video, interview, surveys and Belbin profiles. Multiple observers/assessors are used to ensure minimal personal bias: assessments must agree to >90% consistency in small time periods and assessments must agree to over 95% correlation across entire observation period. Qualitative results derived from individual interviews are used to better understand the major issues facing the team and direct observation of team interactions, both at the top team level and below. Quantitative results derived from video recording and post analysis of team meetings generate metrics for discussion and ongoing comparison as the team works on corrective actions. Belbin profiles highlight team composition balance/imbalance and provide a framework for individual coaching (if desired). Survey forms provide data as to how individuals spend their time.

The assessment outputs include: Strengths/Opportunity Summary, Time Spent Inventory, Belbin Team Map & Implications, Learning Cycle Scorecard, Participation Rate (Overall Balance & Timeline, Power Gap), Decision Stream Analysis and Decision Style Summary. The Strengths Summary includes: (1) Solid foundation of experienced executives on team with a variety of strengths; (2) Strong, visionary leader; (3) Commitment to XYZ organization; (4) Strong desire on the part of all team members to develop high performance teamwork; (5) A recent history of working on team performance that provides a foundation for future team development; (6) Belbin coherence is very high—this should allow much faster progress towards high performance teamwork; and (7) High customer responsiveness. The Opportunities Summary includes: Understanding and playing to the diverse strengths in the team more effectively (utilizing Belbin team roles); Gaining awareness at the individual level of the “power gap” in operation and how it possibly cascades down the organization; Developing several of the basic process skills in team management; Developing dynamic team management skills (Advocacy/inquiry, Participation equality, Utilizing constructive conflict).

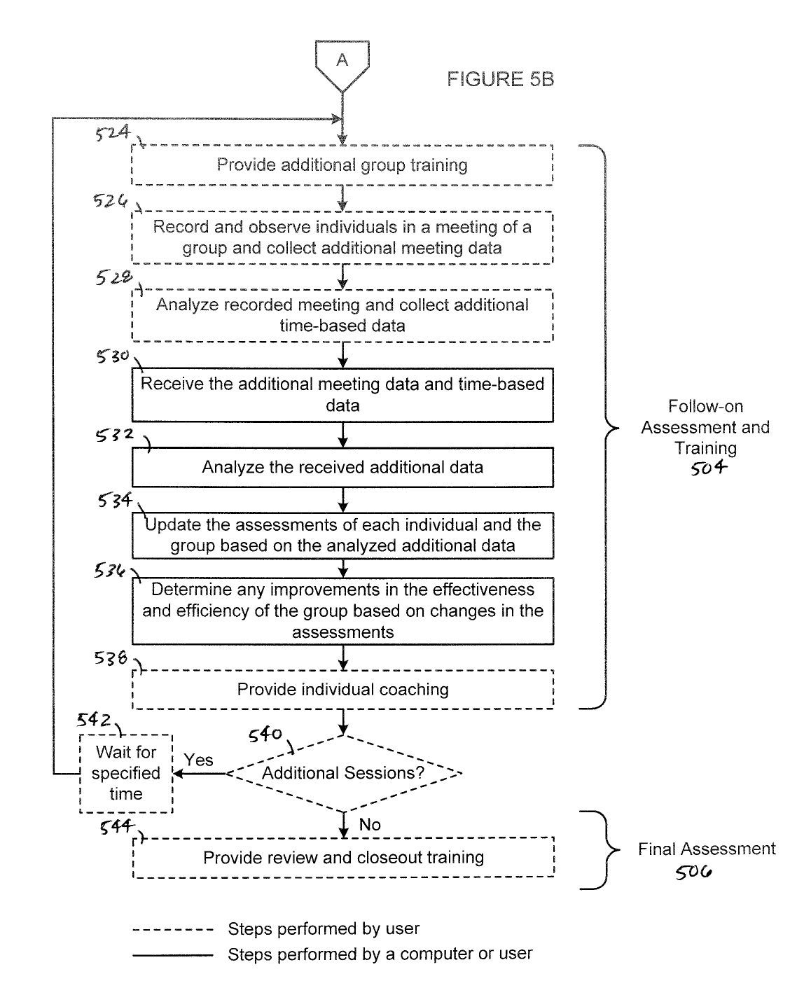

Now referring to FIGS. 5A-5B, flow charts of a method 500 for improving the effectiveness and efficiency of a group in accordance with another embodiment of the present invention are shown. The process involves three stages: (a) initial assessment and training 502 (blocks 508-522), (b) follow-on assessment and training 504 (blocks 524-538), and (c) final assessment and closeout 506 (block 544). The group can be a management team, a production team, a project team, an assembly team, a division of an organization, a sector of the organization or the organization as a whole. Individuals of the group are observed and recorded via video tape or other electronic means during a meeting of the group and data about the meeting is (“meeting data”) collected in block 508. Each individual is interviewed and individual data is collected in block 510. The recorded meeting is analyzed and time-based data is collected in block 512. The meeting data, individual data and time-based data is received in block 514 and the received data is analyzed in block 516. The data may include interview data, meeting observation data, video data or a combination thereof. Moreover, the data may fit within a data-driven analytical framework to measure, diagnose and monitor interaction and performance within the group. An assessment of each individual and the group based on the analyzed data is provided in block 518. The assessment includes three or more assessment outputs selected from a group comprising a FEMA overview, a Belbin team map, a learning cycle scorecard, a participation timeline, an equality index, a power gap and a decision stream analysis. Training materials are identified based on the assessments in block 520. The assessments and training materials are presented to the group in a workshop, and a corrective action plan is created with the group in block 522.

After a specified period of time, such as a month, additional group training is provided in block 524. Note that the specified time period can be any time period, but is typically between one and six months. Individuals of the group are again observed and recorded via video tape or other electronic means during a meeting of the group and additional data about the meeting is (“additional meeting data”) collected in block 526. The recorded meeting is analyzed and additional time-based data is collected in block 528. The additional meeting data and time-based data is received in block 530 and the received additional data is analyzed in block 532. The data may include interview data, meeting observation data, video data or a combination thereof. Moreover, the data may fit within a data-driven analytical framework to measure, diagnose and monitor interaction and performance within the group. The assessments of each individual and the group are updated based on the analyzed additional data in block 536. The assessment includes three or more assessment outputs selected from a group comprising a FEMA overview, a Belbin team map, a learning cycle scorecard, a participation timeline, an equality index, a power gap and a decision stream analysis. Any improvements in the effectiveness and efficiency of the group are determined in block 536 based on changes in the assessments. Individual coaching (onsite, remote or both) is provided in block 538. If additional sessions are required, as determined in decision block 540, the additional sessions are delayed until a specified time has elapsed in block 542. Thereafter, the additional group training is provided in block 524 and the process continues as previously described.

If, however, no additional sessions are required, as determined in decision block 540, a review and closeout training is provided in block 544. Refresher courses and additional assessments can be provided at greater intervals if desired. Note that the steps shown in dashed-lined blocks are performed by a user (e.g., trainer) of the present invention, and steps shown in solid-lined blocks can be performed by a computer or a user. The assessments and training materials are presented to the group in a workshop, and a corrective action plan is created with the group in block 522.

The sessions or workshops may include three or more topics selected from a group comprising understanding leadership models, Belbin team roles and team map exercise, learning how to learn, personal feedback, recognizing leadership styles, double loop learning and team action planning. Furthermore, the workshop may facilitate an experiential training which illustrates a set of tools, techniques and methodology required for faster and better decision-making. Other steps may include: (1) providing additional training, workshops or coaching as necessary for the group to further team development and best optimize executive effectiveness outside of team-based interactions; (2) creating an action plan based on the assessment; or (3) providing additional training to one or more of the individuals or the group as a whole. The action plan may be prepared in conjunction with the group to enable an acceleration of results of other teams throughout an organization.

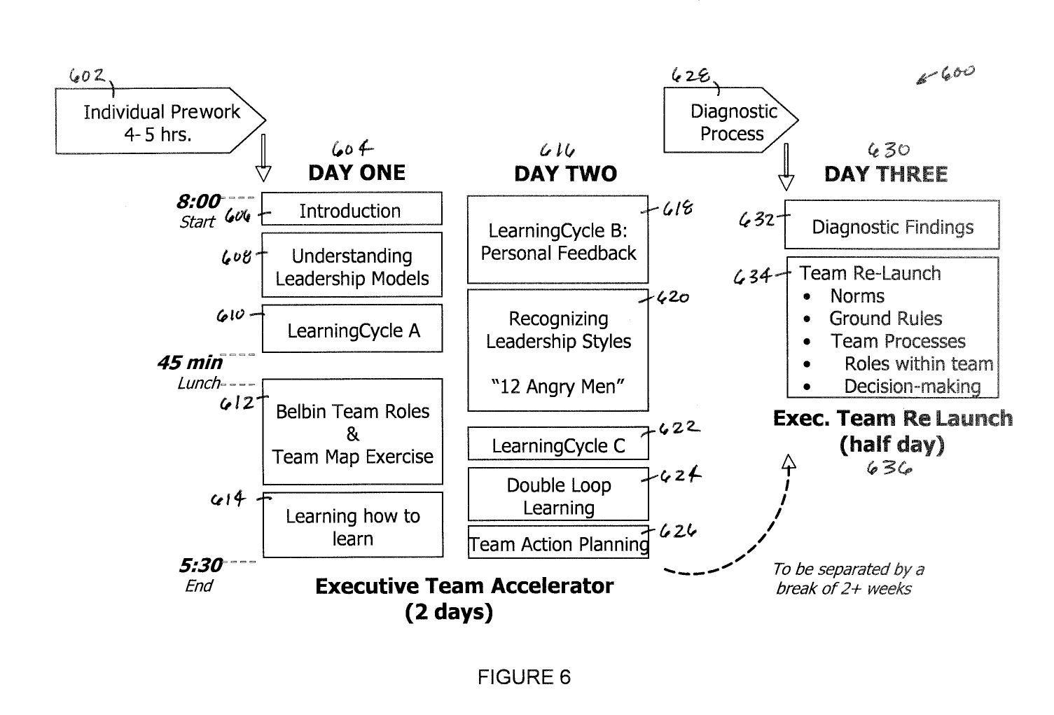

For example, FIG. 6 shows a block diagram of an example of topics used in a three day session or workshop 600 in accordance with the present invention. Before the workshop, the individuals of the group are given homework 602 to prepare them for the workshop and provided individual data for the assessments. The following topics are presented on Day One 604: an introduction 606, understanding leadership models 608, Learning Cycle A 610, Belbin Team Roles and Team Map exercise 612, and learning how to learn 614. The following topics are presented on Day Two 616: Learning Cycle B (personal feedback) 618, recognizing leadership styles 620, Learning Cycle C 622, Double Loop Learning 624 and Team Action planning 626. A diagnostic process 628 is performed between Day Two 616 and Day Three 630 during a break of two or more weeks. The following topics are presented at Day Three 630: diagnostic findings 632 and Team Re-Launch 634 (norms, ground rules, team processes, roles within the team and decision-making). An Executive Team Re-Launch 636 can also be provided.

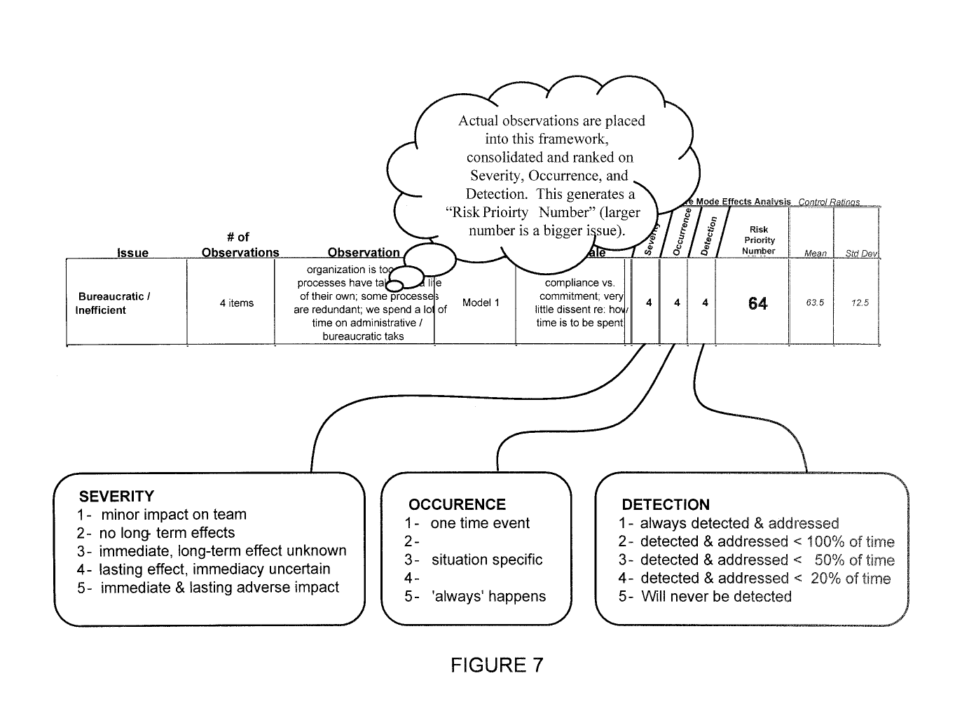

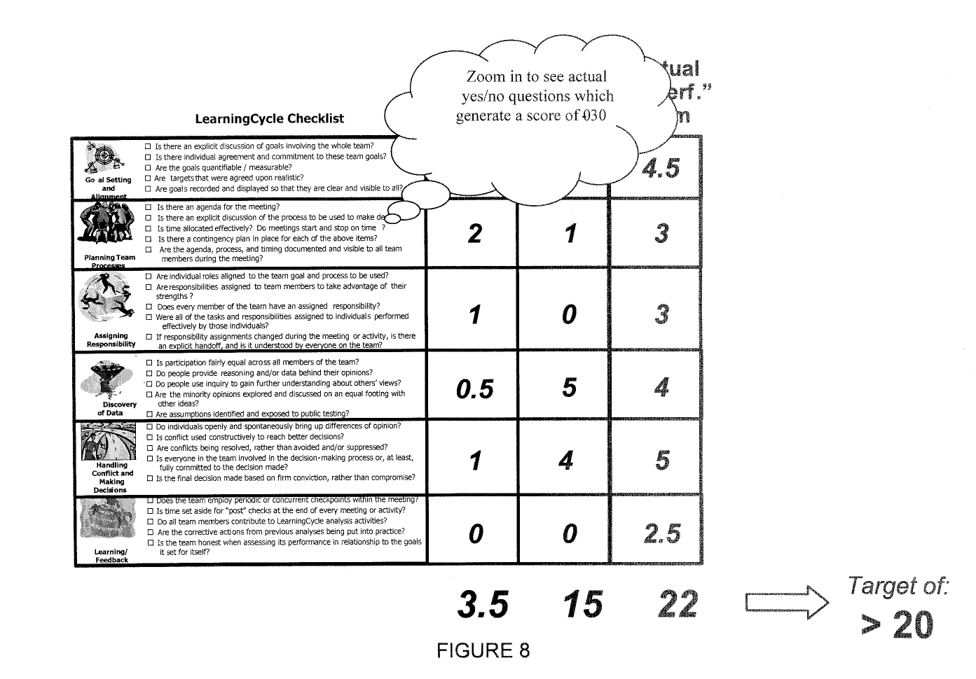

Now referring to FIGS. 7-16, examples of the data, analysis and results using the present invention are shown. FIG. 7 is an example of a FEMA overview for one issue for an individual in accordance with the present invention. FIG. 8 is an example of a learning cycle scorecard for an individual in accordance with the present invention.

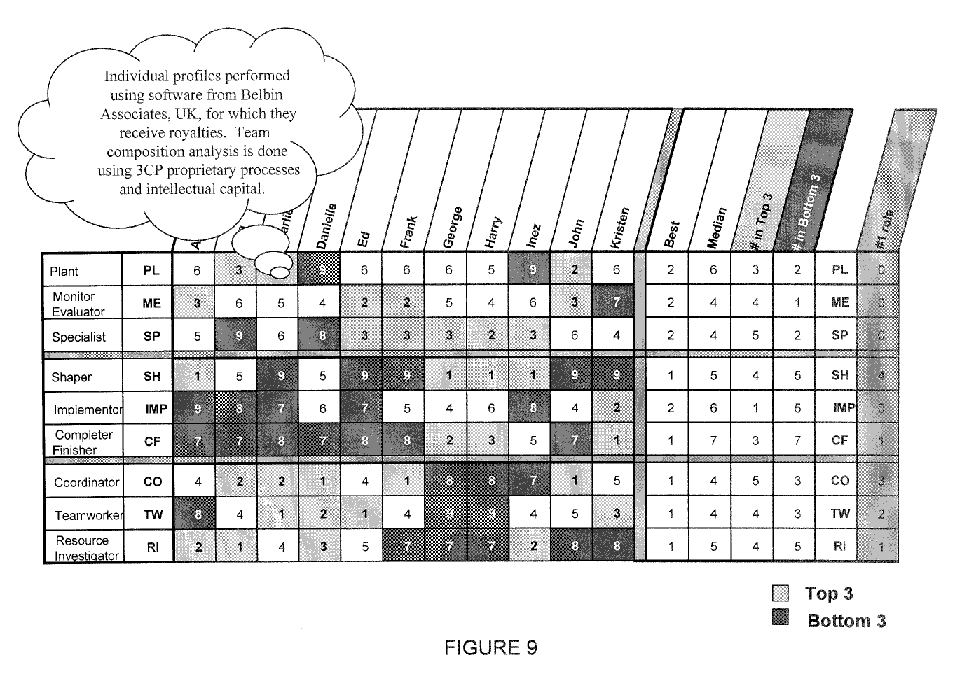

FIG. 9 is an example of a Belbin team map for a group in accordance with the present invention. Belbin Team Role Theory can be used to compile an analysis of the group. An example of such an analysis is provided below:
SH is strongly divided between two extremes (1's and 9's)
   This dynamic could be one of the explanations for the team wrestling with conflict: several members are very comfortable with conflict; others with very low SH scores may find conflict very uncomfortable. This dynamic is unlikely to change as Belbin roles are fairly fixed.
   If the SH role is combined with a 9,1 Grid orientation, teamwork will be impacted and conflict suppressed, leading to less discovery of data.
PL role is somewhat weak; it is also unlikely to emerge in the presence of the SH dynamic (but would under a CO dynamic).
SH/CO are power based roles; there are two distinct groupings evident around the exercise of power
   The SH and CO approaches to leadership can be very different, the former demanding action, the latter seeking consensus. As Belbin proved, if the strength of both can be harnessed, superior results are achieved; if role toxicity develops (as often is the case in the absence of a theoretical intervention) results can be very severely impacted.
   CO's are likely to back off and create their own “compartments” in which they can lead according to their value system, which is more consensus oriented.
   Team Awareness of issues such as this one (being illuminated by a Belbin map) can lead to better Team Management, which in turn can drive high performance teamwork in which continuous learning occurs.
   This situation is not unusual where there are leaders of large groups that come together as a “top team”. Such a team is really more of a collection of peers than what we would usually refer to as a team. Interdependence is usually not as critical an element in such a team's effectiveness. One-on-one and one-on-some relationships could be more important in such teams.
Potential for divisiveness within the team:
   Four strong SH roles (including the leader)
   A preponderance of weakness in the practically oriented Action Roles (Imp and Cf)
   A predominance of strong People Roles roles in the people category.
These factors could subtly, over time, lead to divisiveness in the team. Again, awareness and management of this natural “team personality” is how a team can mitigate against a negative dynamic and take steps to counteract the negative elements of the natural structure of the team.

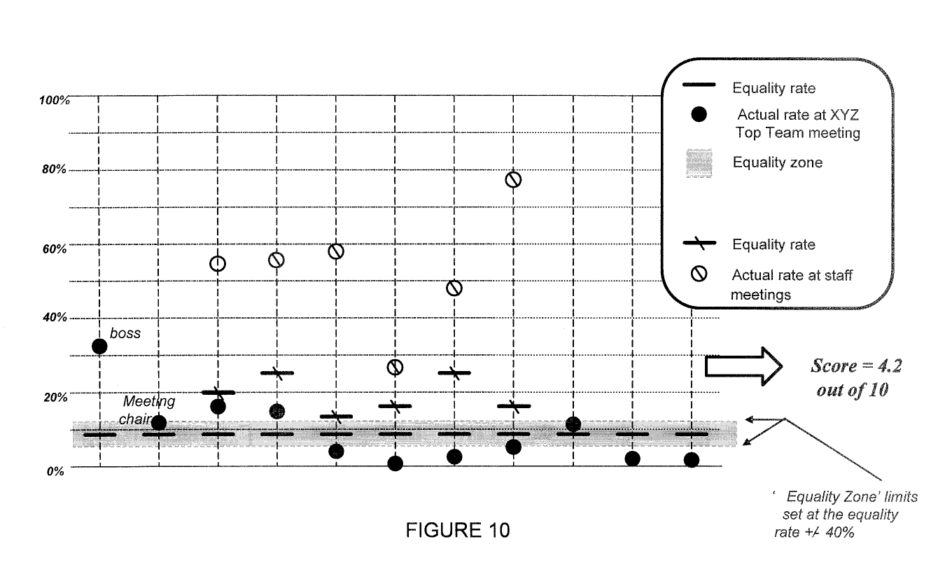

FIG. 10 is an example of a participation rate graph for a group in accordance with the present invention. The Participation Equality Index has a best final score=10 (0 “inequality” points) and a worst final score=0 (set to 50% of the maximum “inequality” points—one person at 100%, all others at 0%). An example for 10 person team is shown below:

Limits are 7-14% ‘safe zone’

Max score:
One person at 100% 86 points
All others at 0% 7 points×9 people
Max=86+(9×7)=149 points

Range=0 to 75 points
Corresponds to a score of 10 to 0

Actual Score
Participation rates of:
   40, 20, 15, 10, 8, 7, 5, 5, 0, 0→26, 6, 1, 0, 0, 0, 2, 2, 7, 7→51 total
Score=10×(1−(51/75))=3.3
   Minimum score will be zero

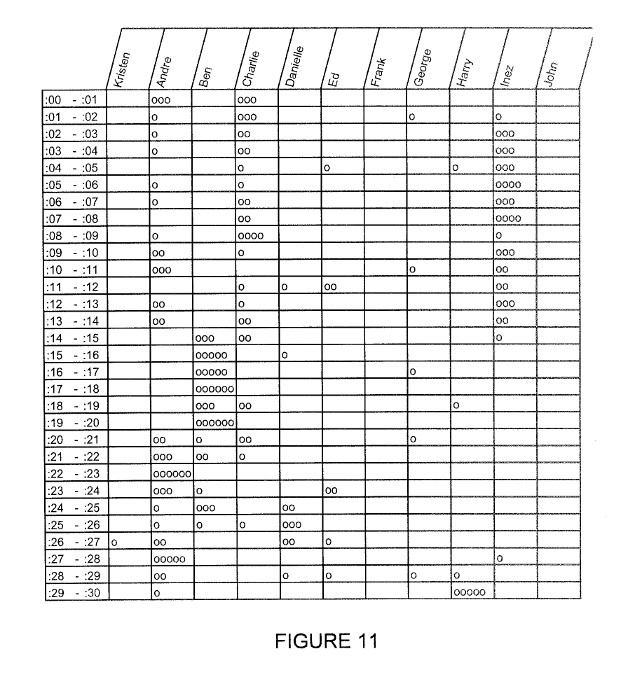

FIG. 11 is an example of a participation timeline for a group in accordance with the present invention. Each observer allocates 6 ‘dots’ per minute of video. Each dot represents roughly 10 seconds of ‘air time’. However, speaking at all (even 2-3 seconds) will usually earn a dot. This display often shows participation patterns as well as aggregate rates, examples: a long monologue, long silences, always interjecting, etc.

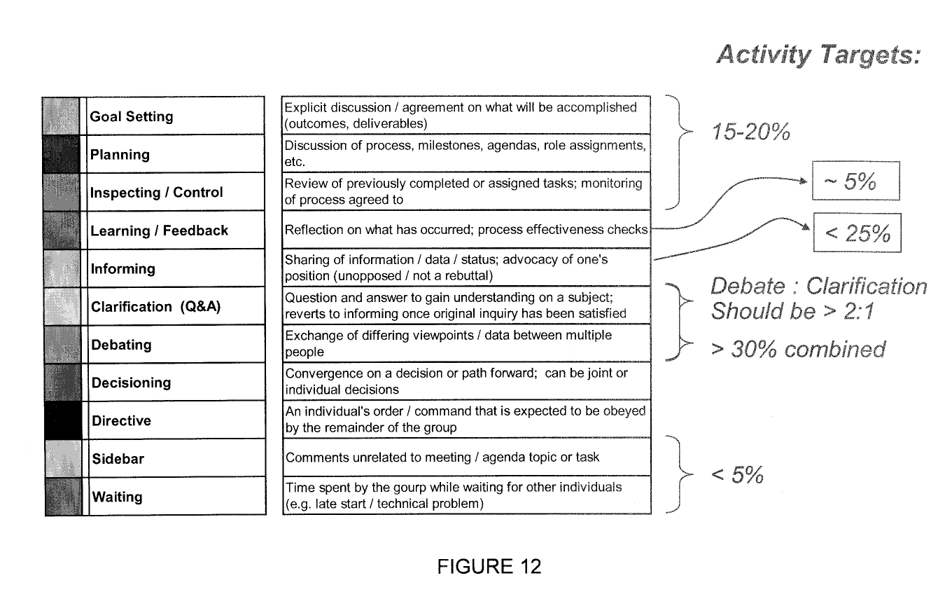

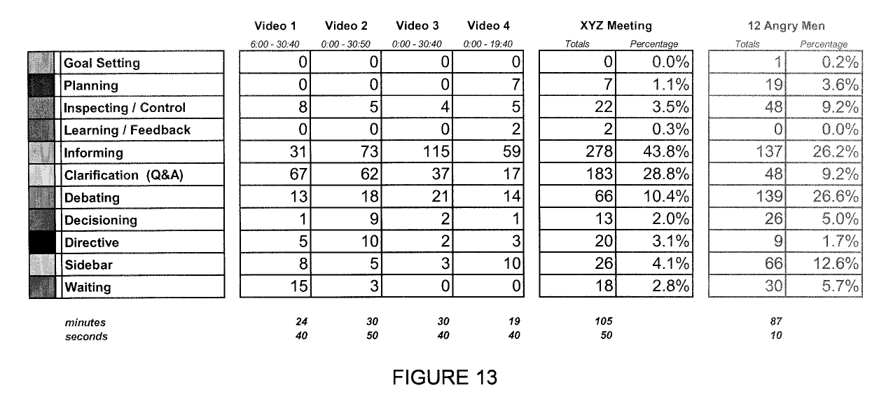

FIG. 12 is an example of definitions for a decision stream analysis in accordance with the present invention. FIG. 13 is an example of a summary for a decision stream analysis in accordance with the present invention.

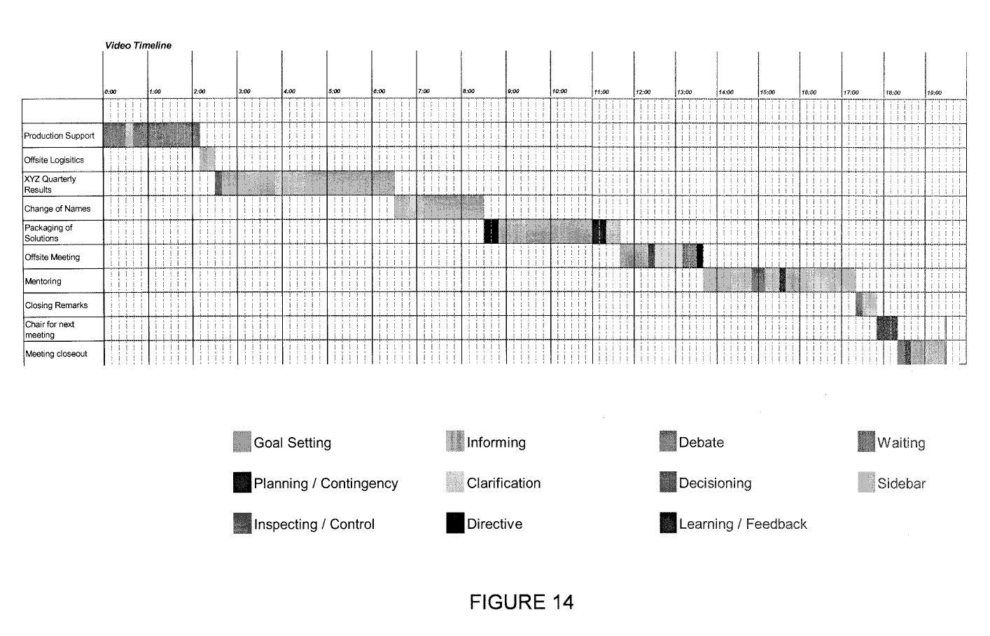

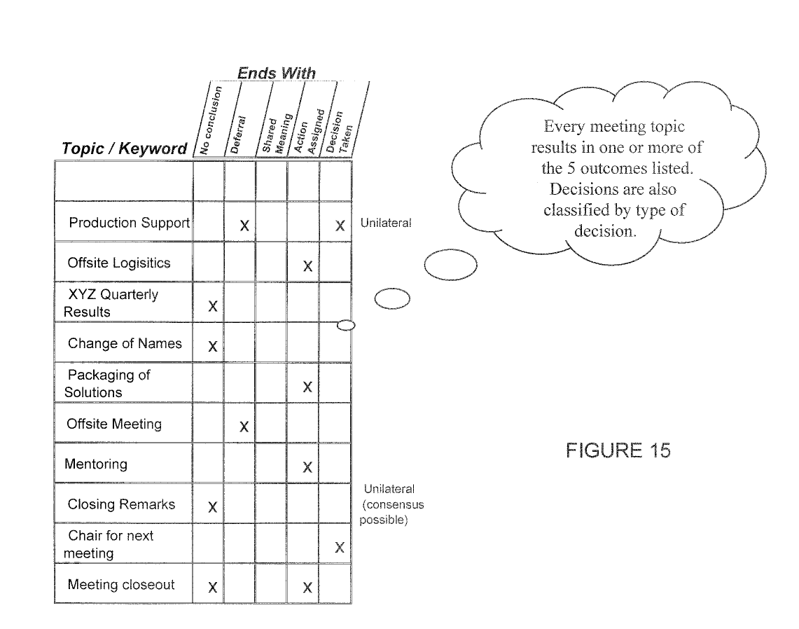

FIGS. 14 and 15 are examples of graphs of raw data for a decision stream analysis in accordance with the present invention. The video time line of FIG. 14 is broken down into ten minute increments and graphically shows the following:

Production Support

| | |
|---|---|
| Debate | 0:00-0:30 |
| Sidebar | 0:30-0:40 |
| Debate | 0:40-2:10 |

Offsite Logistics

| | |
|---|---|
| Informing | 2:10-2:20 |
| Clarification | 2:20-2:30 |

XYZ Quarterly Results

| | |
|---|---|
| Inspecting/Control | 2:30-2:40 |
| Informing | 2:40-3:20 |
| Sidebar | 3:20-3:30 |
| Informing | 3:40-3:50 |
| Clarification | 3:50-4:00 |
| Informing | 4:00-6:30 |

Change of Names

| | |
|---|---|
| Informing | 6:30-6:50 |
| Sidebar | 6:50-7:00 |
| Informing | 7:00-8:30 |

Packaging of Solutions

| | |
|---|---|
| Directive | 8:30-8:50 |
| Informing | 8:50-11:00 |
| Planning/Contingency | 11:00-11:20 |
| Informing | 11:20-11:40 |

Offsite Meeting

| | |
|---|---|
| Informing | 11:40-12:20 |
| Decisioning | 12:30-12:40 |
| Clarification | 12:40-13:10 |
| Debate | 13:10-13:30 |
| Learning/Feedback | 13:30-13:40 |

Mentoring

| | |
|---|---|
| Informing | 13:40-14:20 |
| Clarification | 14:20-14:50 |
| Inspecting/Control | 14:50-15:10 |
| Clarification | 15:10-15:30 |
| Planning/Contingency | 15:30-15:50 |
| Informing | 15:40-16:00 |
| Clarification | 16:00-16:40 |
| Sidebar | 16:40-17:20 |

Closing Remarks

| | |
|---|---|
| Inspecting/Control | 17:20-17:30 |
| Clarification | 17:30-17:50 |

Chair for next meeting

| | |
|---|---|
| Planning/Contingency | 17:50-18:20 |

Meeting Closeout

| | |
|---|---|
| Inspecting/Control | 18:20-18:30 |
| Planning/Contingency | 18:30-18:40 |
| Goal Setting | 18:40-19:00 |
| Sidebar | 19:00-19:30 |

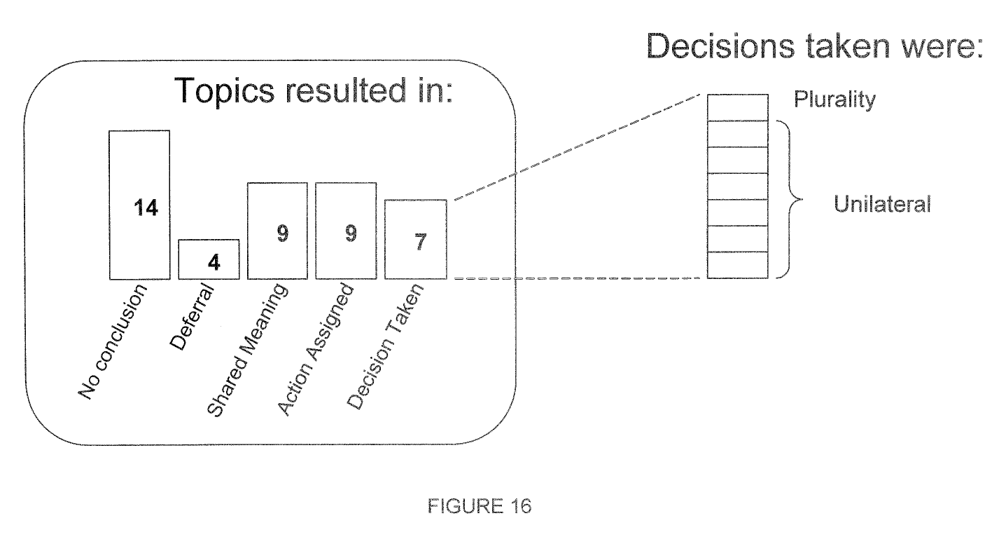

FIG. 16 is a graph of an example of decision styles in accordance with the present invention. The following table describes the various decision styles:

Decision Styles

| | |
|---|---|
| Unanimous | All parties must formally agree |
| Consensus | Majority position will be final, but all minority |
| | parties must agree to support that decision. Any |
| | dissent (veto) requires revisions to remove the |
| | objectionable elements. |
| Majority or | 50% or more support the decision; minority |
| Super-majority | parties do not have right to block decision. |
| | Percentage may be set higher as well (60%, 66% |
| | 75% typical). |
| Multi-vote or | Each party is given multiple votes to apply to a |
| Range-vote | list of alternative decisions. Votes are often |
| | limited to: a fixed number (3 or 5) or a fraction |
| | of the alternatives (⅓, ⅕). The top vote- |
| | getting alternative(s) is selected as final |
| | decision. |
| Plurality | Largest block decides, even if this falls short of |
| | a majority. Minorities do not have have right to |
| | block decision. |
| Subcommittee | A subset of the larger group is assigned to |
| | evaluate a decision and make recommendations |
| | to the larger group. Committee members may be |
| | stakeholders or neutral parties, depending on the |
| | situation under study. |
| Unilateral | One member (often the highest ranking) makes a |
| | decision for the group, or that affects the group. |
| | No challenge or input from others occurs. |

By using the present invention, the team has: (1) an objective assessment of its current state; (2) benchmarks and metrics available to provide an avenue for the development of world class team performance; (3) gone through a shared experience (the awareness workshop) to provide a theoretical framework that can be used as a guide to improved performance as a team; and (4) a review of the Interaction Forensics metrics, followed by action planning and monitoring of outcomes, is a definite avenue for this team to reach high performance teamwork (and the results that emanate from that state).

It will be understood by those of skill in the art that steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for improving an effectiveness and efficiency of a group having two or more individuals, the method comprising the steps of:
(a) receiving data for each individual in the group relating to the effectiveness and efficiency of the group;
(b) analyzing the received data;
(c) providing an assessment of each individual and the group based on the analyzed data wherein the assessment comprises three or more assessment outputs selected from a group comprising a FEMA overview, a Belbin team map, a learning cycle scorecard, a participation timeline, an equality index, a power gap and a decision stream analysis; and
(d) repeating steps (a), (b) and (c) after a specified time period.

2. The method as recited in claim 1, wherein the data comprises interview data, meeting observation data, video data or a combination thereof.

3. The method as recited in claim 1, wherein the data fits within a data-driven analytical framework to measure, diagnose and monitor interaction and performance within the group.

4. The method as recited in claim 1, further comprising the step of providing a workshop for the group.

5. The method as recited in claim 4, wherein the workshop comprises three or more topics selected from a group comprising understanding leadership models, Belbin team roles and team map exercise, learning how to learn, personal feedback, recognizing leadership styles, double loop learning and team action planning.

6. The method as recited in claim 4, wherein the workshop facilitates an experiential training which illustrates a set of tools, techniques and methodology required for faster and better decision-making.

7. The method as recited in claim 1, wherein step (d) monitors any improvement in the effectiveness and efficiency of the group.

8. The method as recited in claim 1, further comprising the steps of providing additional training, workshops or coaching as necessary for the group to further team development and best optimize executive effectiveness outside of team-based interactions.

9. The method as recited in claim 1, further comprising the step of creating an action plan based on the assessment.

10. The method as recited in claim 1, wherein the action plan is prepared in conjunction with the group to enable an acceleration of results of other teams throughout an organization.

11. The method as recited in claim 1, further comprising the step of providing additional training to one or more of the individuals or the group as a whole.

12. The method as recited in claim 1, wherein the specified time period is between one and six months.

13. The method as recited in claim 1, wherein the group comprises a management team, a production team, a project team, an assembly team, a division of an organization, a sector of the organization or the organization as a whole.

14. A computer readable medium encoded with a computer program for improving an effectiveness and efficiency of a group having two or more individuals comprising:
(a) a code segment for receiving data for each individual in the group relating to the effectiveness and efficiency of the group;
(b) a code segment for analyzing the received data;
(c) a code segment for providing an assessment of each individual and the group based on the analyzed data wherein the assessment comprises three or more assessment outputs selected from a group comprising a FEMA overview, a Belbin team map, a learning cycle scorecard, a participation timeline, an equality index, a power gap and a decision stream analysis; and
(d) a code segment for repeating steps (a), (b) and (c) after a specified time period.

15. The computer readable medium encoded with the computer program as recited in claim 14, wherein the data comprises interview data, meeting observation data, video data or a combination thereof.

16. The computer readable medium encoded with the computer program as recited in claim 14, wherein the data fits within a data-driven analytical framework to measure, diagnose and monitor interaction and performance within the group.

17. The computer readable medium encoded with the computer program as recited in claim 14, wherein step (d) monitors any improvement in the effectiveness and efficiency of the group.

18. The computer readable medium encoded with the computer program as recited in claim 14, further comprising a code segment for creating an action plan based on the assessment.

19. The computer readable medium encoded with the computer program as recited in claim 14, wherein the specified time period is between one and six months.

20. The computer readable medium encoded with the computer program as recited in claim 14, wherein the group comprises a management team, a production team, a project team, an assembly team, a division of an organization, a sector of the organization or the organization as a whole.

21. An apparatus for improving an effectiveness and efficiency of a group having two or more individuals, the apparatus comprising:
a memory;
one or more input/output devices; and
a processor communicably coupled to the memory and the input/output device(s) wherein the processor is configured to (a) receive data for each individual in the group relating to the effectiveness and efficiency of the group via the input/output device(s), (b) analyze the received data, (c) provide an assessment via the input/output device(s) of each individual and the group based on the analyzed data wherein the assessment comprises three or more assessment outputs selected from a group comprising a FEMA overview, a Belbin team map, a learning cycle scorecard, a participation timeline, an equality index, a power gap and a decision stream analysis, and repeat (a), (b) and (c) after a specified time period.

22. The apparatus as recited in claim 21, wherein the data comprises interview data, meeting observation data, video data or a combination thereof.

23. The apparatus as recited in claim 21, wherein the data fits within a data-driven analytical framework to measure, diagnose and monitor interaction and performance within the group.

24. The apparatus as recited in claim 21, wherein the processor is further configured to monitor any improvement in the effectiveness and efficiency of the group.

25. The apparatus as recited in claim 21, wherein the processor is further configured to create an action plan based on the assessment.

26. The apparatus as recited in claim 21, wherein the specified time period is between one and six months.

27. The apparatus as recited in claim 21, wherein the group comprises a management team, a production team, a project team, an assembly team, a division of an organization, a sector of the organization or the organization as a whole.
